(19) United States
(12) Patent Application Publication
(10) Pub. No.: US 2024/0300824 A1
(43) Pub. Date: Sep. 12, 2024

(54) LITHIUM NICKEL-BASED COMPOSITE OXIDE AS A POSITIVE ELECTRODE ACTIVE MATERIAL FOR RECHARGEABLE LITHIUM-ION BATTERIES

(71) Applicant: UMICORE, Brussels (BE)

(72) Inventors: Jens Martin PAULSEN, Chungcheongnam-do (KR); Shinichi KUMAKURA, Olen (BE); TaeHyeon YANG, Chungcheongnam-do (KR); HyeJeong YANG, Chungcheongnam-do (KR); JiHoon KANG, Chungcheongnam-do (KR); JinDoo OH, Chungcheongnam-do (KR); JooEun HYOUNG, Chungcheongnam-do (KR)

(21) Appl. No.: 18/277,543

(22) PCT Filed: Feb. 24, 2022
(86) PCT No.: PCT/EP2022/054606

§ 371 Date: Aug. 16, 2023

(30) Foreign Application Priority Data
Feb. 25, 2021 (EP) 21159378.5
Feb. 25, 2021 (EP) 21159385.0
Feb. 25, 2021 (EP) 21159397.5
Feb. 25, 2021 (EP) 21159402.3

(51) Int. Cl. C01G 53/00

(52) U.S. Cl. CPC C01G 53/50; C01P 2002/85; C01P 2004/03; C01P 2004/51; C01P 2004/62; C01P 2006/40; C01P 2006/80

(57) ABSTRACT

Positive electrode active material for solid-state batteries, comprising Li, M′, and oxygen, wherein M′ comprises:
Ni in a content x between 70.0 mol % and 95.0 mol %,
Co in a content y between 0.0 mol % and 40.0 mol %,
Mn in a content z between 0.0 mol % and 40.0 mol %,
dopants in a content a between 0.0 mol % and 2.0 mol %,
Zr in a content b between 0.1 mol % and 5.0 mol %,
wherein x+y+z+a+b is 100.0 mol %,
   wherein

$${Zr}_{A} = \frac{b}{( x + y + z + b )} ,$$

wherein the positive electrode active material has a Zr content Zr_{B} is expressed as molar fraction compared to the sum of molar fractions of Co, Mn, Ni, and Zr all as measured by XPS analysis,
wherein Zr_{B}/Zr_{A}>50.0,
the positive electrode active material comprising secondary particles having a plurality of primary particles,
said primary particles having an average diameter of at least 250 nm.

### TECHNICAL FIELD AND BACKGROUND

This invention relates to a lithium nickel-based oxide positive electrode active material for solid-state batteries suitable for electric vehicle (EV) and hybrid electric vehicle (HEV) applications, comprising lithium nickel-based oxide particles comprising zirconium (Zr).

A positive electrode active material is defined as a material which is electrochemically active in a positive electrode. By active material, it must be understood a material capable to capture and release Li ions when subjected to a voltage change over a predetermined period of time.

In the framework of the present invention, at % signifies atomic percentage. The at % or “atom percent” of a given element expression of a concentration means how many percent of all atoms in the claimed compound are atoms of said element. The designation at % is equivalent to mol % or “molar percent”.

The weight percent (wt %) of a first element E (E_{wt1}) in a material can be converted from a given atomic percent (at %) of said first element E (Eₐₜ₁) in said material by applying the following formula:

$${E}_{wt 1} = \frac{( {E}_{at 1} \times {E}_{aw 1} )}{{\sum }_{i = 1}^{n} ( {E}_{ati} \times {E}_{awi} )} \times 100 \% ,$$

wherein the product of Eₐₜ₁ with E_{aw1}, E_{aw1} being the atomic weight (or molecular weight) of the first element E, is divided by the sum of Eₐₜ₁×E_{awi} for the other elements in the material. n is an integer which represents the number of different elements included in the material.

It is an object of the present invention to provide a positive electrode active material having an improved first charge capacity of at least 160 mAh/g in the solid-state battery.

### SUMMARY OF THE INVENTION

This objective is achieved by providing a positive electrode active material for solid-state batteries, wherein the positive electrode active material comprises Li, M′, and oxygen, wherein M′ comprises:
Ni in a content x between 70.0 mol % and 95.0 mol %, relative to M′;
Co in a content y between 0.0 mol % and 40.0 mol %, relative to M′;
Mn in a content z between 0.0 mol % and 40.0 mol %, relative to M′,
D in a content a between 0.0 mol % and 2.0 mol %, relative to the total atomic content of M′, wherein D comprises at least one element of the group consisting of: Al, B, Ba, Ca, Cr, Fe, Mg, Mo, Nb, S, Si, Sr, Ti, Y, V, W, and Zn, and,
Zr in a content b between 0.1 mol % and 5.0 mol %, relative to M′, wherein x, y, z, a, and b are measured by ICP,
wherein x+y+z+a+b is 100.0 mol %,
   wherein the positive electrode active material has a Zr content Zr_{A} defined as

$$\frac{b}{( x + y + z + b )} ,$$

wherein the positive electrode active material has a Zr content Zr_{B}, wherein Zr_{B} is determined by XPS analysis, wherein Zr_{B} is expressed as molar fractions compared to the sum of molar fractions of Co, Mn, Ni, and Zr, as measured by XPS analysis,
wherein the ratio Zr_{B}/Zr_{A}>50.0,
wherein the positive electrode active material comprises secondary particles having a plurality of primary particles,
wherein said primary particles have an average diameter of at least 250 nm as determined by measuring primary particle size in an image taken by SEM.

The present invention concerns the following embodiments:

### Embodiment 1

In a first aspect, the present invention concerns a positive electrode active material for solid-state batteries, wherein the positive electrode active material comprises Li, M′, and oxygen, wherein M′ comprises:
Ni in a content x between 70.0 mol % and 95.0 mol %, relative to M′, preferably Ni in a content x between 75.0 mol % and 95.0 mol %, relative to M′,
Co in a content y between 0.0 mol % and 40.0 mol %, relative to M′,
Mn in a content z between 0.0 mol % and 70.0 mol %, relative to M′, preferably Mn in a content z between 0.0 mol % and 40.0 ml %, relative to M′,
D in a content a between 0.0 mol % and 2.0 mol %, relative to the total atomic content of M′, wherein D comprises at least one element of the group consisting of: Al, B, Ba, Ca, Cr, Fe, Mg, Mo, Nb, S, Si, Sr, Ti, Y, V, W, and Zn, and,
Zr in a content b between 0.1 mol % and 5.0 mol %, relative to M′,
wherein x, y, z, a, and b are measured by ICP,
wherein x+y+z+a+b is 100.0 mol %,
   wherein the positive electrode active material has a Zr content

$${Zr}_{A} = \frac{b}{( x + y + z + b )} ,$$

wherein the positive electrode active material has a Zr content Zr_{B}, wherein Zr_{B} is determined by XPS analysis, wherein Zr_{B} is expressed as molar fractions compared to the sum of molar fractions of Co, Mn, Ni, and Zr, as measured by XPS analysis,
wherein the ratio Zr_{B}/Zr_{A}>50.0.

Note that Zr_{A} is the Zr content of the positive electrode active material as determined by ICP and expressed as a fraction relative to the sum of the contents of Co, Ni, Mn and Zr.

Preferably, the Zr_{B}/Zr_{A} ratio is at least 80, preferably at least 100, more preferably at least 120 and most preferably at least 130. Preferably, the Zr_{B}/Zr_{A} ratio is at most 500, more preferably at most 300, and most preferably at most 200.

Preferably the positive electrode active material comprises secondary particles having a plurality of primary particles and wherein said primary particles have an average diameter of at least 200 nm as determined by measuring primary particle size in the image taken by SEM.

More preferably said primary particles have an average diameter of at least 250 nm, even more preferably of at least 300 nm and most preferably of at least 350 nm. Even more preferably said primary particles have an average diameter of at least 260 nm, preferably of at least 270 nm, even more preferably of at least 280 nm, most preferably of at least 290 nm.

Preferably said primary particles have an average diameter of at most 1000 nm, preferably of at most 600 nm, more preferably of at most 500 nm.

Preferably said primary particles have an average diameter of between 250 nm and 1000 nm, preferably between 300 nm and 600 nm, more preferably between 350 nm and 500 nm.

Preferably, x≥77.0 mol % and more preferably x≥80.0 mol % and even more preferably x>81.0 mol %.

Preferably, x≤91.0 mol % and more preferably x≤90.0 mol %.

Preferably, y>0 mol % and more preferably y≥5.0 mol % and even more preferably y 9.0 mol %.

In another embodiment, said Ni in a content x is between 77 mol % and 90 mol % relative to M′ and said Co in a content y is between 0.0 mol % and 20.0 mol % relative to M′.

In a preferred embodiment Ni is in a content x≥78.0 mol %, preferably x≥80.0 mol %, more preferably x≥82.0 mol %. In a preferred embodiment, x≤92.0 mol % preferably x 90.0 mol % and more preferably x≤88.0 mol %. A more preferred embodiment is the positive electrode active material of the invention, wherein Ni in a content x between 78.0 mol %≤x≤92.0 mol %, preferably 80.0 mol %≤x≤92.0 mol %, more preferably 82.0 mol %≤x≤88.0 mol %.

As appreciated by the skilled person the amount of Li and M′, preferably Li, Ni, Mn, Co, D and Zr in the positive electrode active material is measured with Inductively Coupled Plasma-Optical Emission Spectroscopy (ICP-OES). For example, but not limiting to the invention, an Agilent ICP 720-ES is used in the ICP-OES analysis.

In a preferred embodiment Mn is in a content z>0.0 mol %, more preferably z≥5.0 mol %, and even more preferably z≥8.0 mol %. In a preferred embodiment the content is z≤40.0 mol %, preferably z≤30.0 mol %, and more preferably z≤15.0 mol %. In a preferred embodiment the content is 0.0 mol %<z≤40.0 mol %, preferably 5.0 mol %≤z≤30.0 mol %, more preferably 8.0 mol %≤z≤15.0 mol %.

In a preferred embodiment Co is in a content y>0.0 mol %, more preferably y≥1.0 mol %, and even more preferably y≥3.0 mol %. In a preferred embodiment the content is y≤40.0 mol %, more preferably y≤20.0 mol %, and even more preferably y≤10.0 mol %. In a preferred embodiment the content is 0.0 mol %<y≤40.0 mol %, preferably 1.0 mol % y≤20.0 mol %, more preferably 3.0 mol %≤y≤10.0 mol %.

In a preferred embodiment D comprises at least one element of the group consisting of: Al, B, Ba, Ca, Cr, Fe, Mg, Mo, Nb, S, Si, Sr, Ti, Y, V, W, and Zn; preferably Al, B, Cr, Nb, S, Si, Ti, Y and W.

In a preferred embodiment D is in a content a>0.0 mol %, more preferably a≥0.25 mol %, and even more preferably a≥0.5 mol %. In a preferred embodiment the content is a 2.0 mol %, preferably a 1.75 mol %, and more preferably a 1.5 mol %. In a preferred embodiment the content is 0.0 mol %<z≥2.0 mol %, preferably 0.25 mol %≤z≤1.75 mol % and more preferably 0.5 mol %≤z≤1.5 mol %.

As appreciated by the skilled person the secondary particles comprise of a plurality of primary particles, preferably more than 20 primary particles, preferably more than 10 primary particles, most preferably more than 5 primary particles. Primary particles are particles which are individual crystals or which are formed of less than five, and preferably at most three, primary particles which are themselves individual crystals. This can be observed in proper microscope techniques like Scanning Electron Microscope (SEM) by observing grain boundaries.

### Embodiment 2

In a second embodiment, preferably according to the Embodiment 1, wherein the Zr content Zr_{A} is b/(b+x+y+z) is at least 0.10 mol % and at most 1.00 mol %. Preferably, the Zr content Zr_{A} is b/(b+x+y+z) is at least 0.20 mol % and at most 0.80 mol %. Most preferably the Zr content Zr_{A} is b/(b+x+y+z) is at least 0.30 mol % and at most 0.70 mol %. In an alternative but even preferred embodiment, the Zr content Zr_{A} is b/(b+x+y+z) is at least 0.10 mol % and at most 1.50 mol %. Preferably, the Zr content Zr_{A} is b/(b+x+y+z) is at least 0.20 mol % and at most 1.00 mol %. Most preferably the Zr content Zr_{A} is b/(b+x+y+z) is at least 0.30 mol % and at most 0.90 mol %.

In a preferred embodiment, Zr is in a content b of at least 0.10 mol % and at most 1.00 mol % relative M′, more preferably at least 0.20 mol % and at most 0.80 mol % relative to M′, most preferably at least 0.30 mol % and at most 0.70 mol % relative M′.

In an alternative but even preferred embodiment Zr is in a content b of at least 0.10 mol % and at most 1.50 mol % relative M′, more preferably at least 0.20 mol % and at most 1.00 mol % relative to M′, most preferably at least 0.30 mol % and at most 0.90 mol % relative M′.

In a preferred embodiment the Zr content Zr_{B} is more than 0.25 mol %, preferably more than 0.50 mol %, most preferably more than 0.60 mol %. In a preferred embodiment Zr_{B} is less than 2.0 mol %, preferably less than 1.5 mol %, more preferably less than 1.0 mol %. In a preferred embodiment Zr_{B} is between 0.25 mol % and 2.0 mol %, preferably between 0.50 mol % and 1.5 mol %, most preferably between 0.60 mol % and 1.0 mol %. As appreciated by the skilled person Zr_{B} is expressed as molar fraction, as measured by XPS analysis, compared to the sum of molar fractions of Co, Mn, Ni, and Zr, as measured by XPS analysis.

### Embodiment 3

In a third embodiment, according to Embodiment 1 to 2, said material has a secondary particle median size D50 of at least 2 μm, and preferably of at least 3 μm as determined by laser diffraction particle size analysis.

Preferably, said material has a secondary particle median size D50 of at most 15 μm, and preferably of at most 10 μm as determined by laser diffraction particle size analysis.

For example, but not limiting to the invention, the laser diffraction particle size analysis is performed by a Malvern Mastersizer 3000.

### Embodiment 4

In a fourth embodiment, according to Embodiment 1 to 3, said material has a carbon content of at least 600 ppm, preferably of at least 650 ppm, more preferably of at least 750 and most preferably of at least 900 ppm as determined by carbon analyzer.

Preferably, said material has a carbon content of at most 8000 ppm, preferably of at most 7500 ppm, more preferably of at most 5000 ppm and most preferably of at most 2000 ppm as determined by carbon analyzer.

As appreciated by the skilled person, for any of the Embodiments 1 to 4, Zr_{B} is expressed as molar fraction, as measured by XPS analysis compared to the sum of molar fractions of Co, Mn, Ni, and Zr, as measured by XPS analysis, in particular Zr_{B} is the molar fractions of Zr measured in a region of a secondary particle of the positive electrode active material according to invention defined between a first point of an external edge of said particle and a second point at a distance from said first point, said distance separating said first to said second point being equal to a penetration depth of said XPS, said penetration depth D being comprised between 1.0 to 10.0 nm. In particular, the penetration depth is the distance along an axis perpendicular to a virtual line tangent to said external edge and passing trough said first point.

The external edge of the particle is, in the framework of this invention, the boundary or external limit distinguishing the particle from its external environment.

Therefore, XPS analysis provides atomic content of elements in an uppermost layer of a particle with a penetration depth of about 10.0 nm from an outer boundary of the particle. The outer boundary of the particle is also referred to as “surface”. In the framework of the present invention, at % signifies atomic percentage. The at % or “atomic percent” of a given element expression of a concentration means how many percent of all atoms in the concerned compound are atoms of said element. The designation at % is equivalent to mol % or “molar percent”. For example, but not limiting to the invention, XPS analysis is carried out with a Thermo K-α+ spectrometer (Thermo Scientific).

The present invention concerns a use of the positive electrode active material according to any of the preceding Embodiments 1 to 4 in a battery.

The present invention is also inclusive of a process for manufacturing the positive electrode active material according to any of the preceding Embodiments 1 to 4, comprising the steps of:
preparing a lithium transition metal-based compound,
mixing said lithium transition metal-based compound with a source of Zr, preferably Zr alkoxide in lithium alkoxide containing alcohol solvent, thereby obtaining a mixture, and
removing volatile phases including solvent, preferably by vacuum heating,
heating the mixture in an oxidizing atmosphere in a furnace at a temperature between 350° C. and less than 500° C., preferably at most 450° C., for a time between 1 hour and 20 hours so as to obtain the positive electrode active material powder according to the present invention.

In a preferred embodiment the lithium transition metal-based compound is a lithium nickel-based oxide compound.

In a preferred embodiment of the method the lithium transition metal-based oxide compound comprising Li, M′ and oxygen, wherein M′ comprises Ni, Mn, Co and D, wherein D is at least one element of the group consisting of: Al, B, Ba, Ca, Cr, Fe, Mg, Mo, Nb, S, Si, Sr, Ti, Y, V, W, and Zn; preferably Al, B, Cr, Nb, S, Si, Ti, Y, W.

Preferably the lithium transition metal oxide powder used is also typically prepared according to a lithiation process, that is the process wherein a mixture of a transition metal precursor and a lithium source is heated at a temperature preferably of at least 500° C.

Typically, the transition metal precursor is prepared by coprecipitation of one or more transition metal sources, such as salts, and preferably sulfates of the M′ elements Ni, Mn and/or Co, in the presence of an alkali compound, such as an alkali hydroxide e.g. sodium hydroxide and/or ammonia.

Preferably the method comprises a further step, before heating said mixture, of drying said mixture, preferably by means of vacuum heating.

In a preferred embodiment of the method, the source of Zr is a Zr-alkoxide, preferably Zr-ethoxide, Zr-propoxide or Zr-butoxide, more preferably Zr-propoxide. In a preferred embodiment the Zr-alkoxide is mixed as a solid with the mixture. Alternatively, and more preferably, the Zr alkoxide is mixed as a solution with the slurry, wherein the solution comprises the Zr-alkoxide and a further alcohol, wherein the alkoxide group is a conjugate base of the further alcohol. For example, the Zr-alkoxide is Zr-propoxide, which is dissolved in propanol. Typically, the solution comprises 50-90 wt. % of the Zr-alkoxide by total weight of the solution. Examples of such a solution are a 70 wt. % Zr-propoxide in 1-propanol or a 80 wt. % Zr-butoxide in 1-butanol.

Preferably, the alcohol solvent is methanol, ethanol, propanol or butanol, preferably ethanol.

The present invention is also inclusive of a solid-state battery comprising the positive electrode active material according to any of the preceding Embodiments 1 to 4, preferably the solid-state battery comprises a sulfide based solid electrolyte, more preferably the sulfide based solid electrolyte comprises Li, P and S. Typically, the following sulfur containing compounds of Li₆PS₅Cl (LPSCL), Thio-LISICON (Li_{3.25}Ge_{0.25}P_{0.75}S₄), Li₂S—P₂S₅—LiCl, LiC₂S—SiS₂, LiI—Li₂S—SiS₂, Li—P₂S₅—LiCl, LiC₂S—SiS₂, LiI—Li₂S—SiS₂, LiI—Li₂S—P₂S₅, LiI—Li₂SP₂O₅, LiI—Li₃PO₄—P₂S₅, Li₂S—P₂S₅, Li₃PS₄, Li₇P₃S₁₁, LiI—Li₂S—B₂S₃, Li₃PO₄—Li₂S—SiS₂, Li₃PO₄Li₂S—SiS₂, LiPO₄-Li₂S—SiS₂, Li₁₀GeP₂S₁₂, Li_{9.54}Si_{1.74}P_{1.44}S_{11.7}Cl_{0.3}, and/or Li₇P₃S₁₁ may be suitably used.

### BRIEF DESCRIPTION OF THE FIGURES

FIG. 1a. SEM image shows secondary particle of EX1 comprising plurality of primary particles. Dotted line shows the area to be captured in order to obtain the average primary particle diameter.

FIG. 1b. SEM image of EX1 to obtain the average primary particle diameter.

FIG. 1c. SEM image of EX2 to obtain the average primary particle diameter.

FIG. 1d. SEM image of CEX3.2 to obtain the average primary particle diameter.

FIG. 2. XPS spectra showing Zr peak of EX1 and EX2.

### DETAILED DESCRIPTION

In the drawings and the following detailed description, preferred embodiments are described so as to enable the practice of the invention. Although the invention is described with reference to these specific preferred embodiments, it will be understood that the invention is not limited to these preferred embodiments. The invention includes numerous alternatives, modifications and equivalents that are apparent from consideration of the following detailed description and accompanying drawings.

### A) ICP Analysis

The amount of Li, Ni, Mn, Co, and Zr in the positive electrode active material powder is measured with the Inductively Coupled Plasma (ICP) method by using an Agillent ICP 720-ES (Agilent Technologies, https://www.agilent.com/cs/library/brochures/5990-6497EN%20720-725_ICP-OES_LR.pdf). 2 grams of powder sample is dissolved into 10 mL of high purity hydrochloric acid (at least 37 wt. % of HCl with respect to the total weight of solution) in an Erlenmeyer flask. The flask is covered by a glass and heated on a hot plate at 380° C. until complete dissolution of the precursor. After being cooled to room temperature, the solution of the Erlenmeyer flask is poured into a 250 mL volumetric flask. Afterwards, the volumetric flask is filled with deionized water up to the 250 mL mark, followed by complete homogenization. An appropriate amount of solution is taken out by pipette and transferred into a 250 mL volumetric flask for the 2^{nd} dilution, where the volumetric flask is filled with internal standard and 10% hydrochloric acid up to the 250 mL mark and then homogenized. Finally, this 50 mL solution is used for ICP measurement.

### B) SEM (Scanning Electron Microscope) Analysis

The morphology of positive electrode active materials is analyzed by a Scanning Electron Microscopy (SEM) technique. The measurement is performed with a JEOL JSM 7100F (https://www.jeolbenelux.com/JEOL-BV-News/jsm-7100f-thermal-field-emission-electron-microscope) under a high vacuum environment of 9.6×10⁻⁵ Pa at 25° C.

### C) Particle Size

### C1) Secondary Particle Size Analysis

The particle size distribution (PSD) of the positive electrode active material powder is measured by laser diffraction particle size analysis using a Malvern Mastersizer 3000 with a Hydro MV wet dispersion accessory (https://www.malvernpanalytical.com/en/products/product-range/mastersizer-range/mastersizer-3000 #overview) after having dispersed each of the powder samples in an aqueous medium. In order to improve the dispersion of the powder, sufficient ultrasonic irradiation and stirring is applied, and an appropriate surfactant is introduced. D50 is defined as the particle size at 50% of the cumulative volume % distributions obtained from the Malvern Mastersizer 3000 with Hydro MV measurements.

### C2) Primary Particle Size Analysis

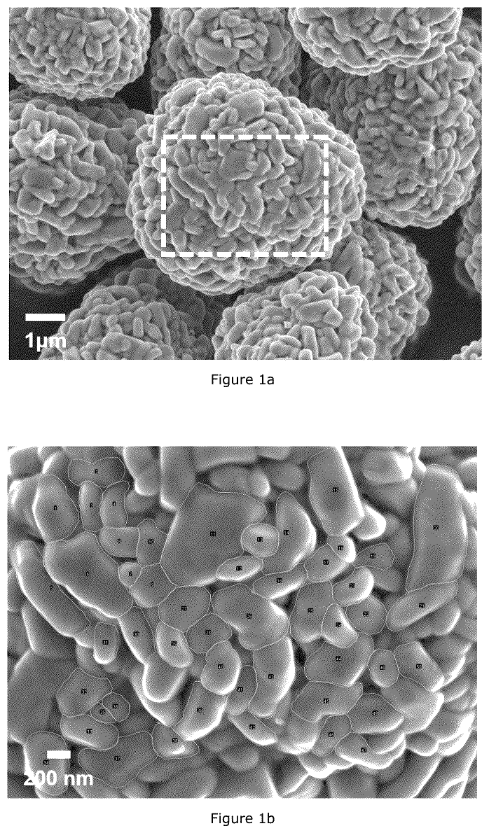

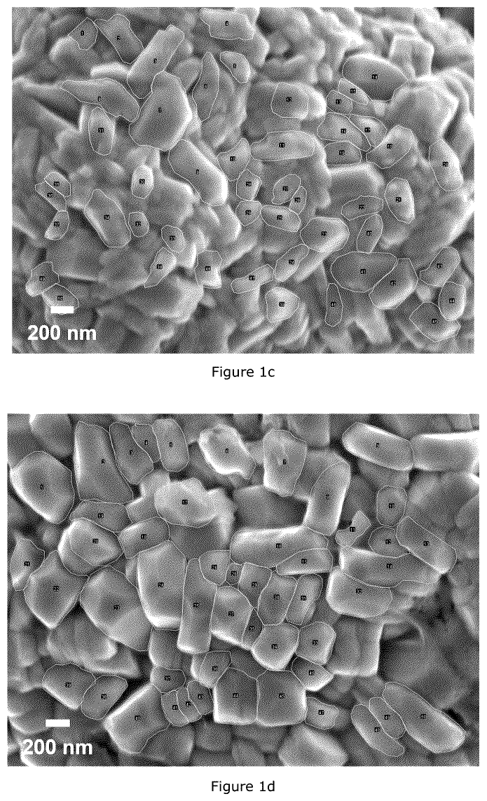

The diameter of primary particle is calculated by using ImageJ software (ImageJ 1.52a, National Institutes of Health, USA) according to the following steps:
Step 1) Open the file containing SEM image of positive electrode active material with 10,000 times magnification wherein the image is taken at the center part of a secondary particle. Example of such image is shown in FIG. 1a wherein the dotted line shows the area to be captured corresponding to FIG. 1b.
Step 2) Set scale according to the SEM magnification.
Step 3) Draw lines following primary particle edges using polygon selections tool for at least 50 particles. The particles at the edges of image is to be excluded if truncated.
Step 4) Measure the area of the drawn primary particles selected from Set Measurements and Area box.
Step 5) Calculate the particle diameter of each measured area by assuming the particle in the spherical shape following

$$d = 2 \times \sqrt{\frac{area}{π}}$$

and obtain the average primary particle diameter for at least 50 particles.

### D) X-Ray Photoelectron Spectroscopy Analysis

In the present invention, X-ray photoelectron spectroscopy (XPS) is used to analyze the surface of positive electrode active material powder particles. In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of positive electrode active material powder particles, XPS measurement is carried out using a Thermo K-α+ spectrometer (Thermo Scientific, https://www.thermofisher.com/order/catalog/product/IQLAADGAAFFACVMAHV). Monochromatic Al Kα radiation (hu=1486.6 eV) is used with a spot size of 400 μm and measurement angle of 45°. A wide survey scan to identify elements present at the surface is conducted at 200 eV pass energy. Cis peak having a maximum intensity (or centered) at a binding energy of 284.8 eV is used as a calibrate peak position after data collection. Accurate narrow scans are performed afterwards at 50 eV for at least 10 scans for each identified element to determine the precise surface composition.

Curve fitting is done with CasaXPS Version2.3.19PR1.0 (Casa Software, http://www.casaxps.com/) using a Shirley-type background treatment and Scofield sensitivity factors. The fitting parameters are according to Table 1a. Line shape GL(30) is the Gaussian/Lorentzian product formula with 70% Gaussian line and 30% Lorentzian line. LA(α, β, m) is an asymmetric line-shape where a and R define tail spreading of the peak and m define the width.

TABLE 1a
XPS fitting parameter for Ni2p3, Mn2p3, Co2p3, and Zr3d1.

| | Sensitivity | Fitting range | Defined | Line |
|---|---|---|---|---|
| Element | factor | (eV) | peak(s) | shape |
| Ni | 14.61 | 851.3 ± 0.1- | Ni2p3, Ni2p3 | LA(1.33, |
| | | 869.4 ± 0.1 | satellite | 2.44, 69) |
| Mn | 9.17 | 639.9 ± 0.1- | Mn2p3, Mn2p3 | GL(30) |
| | | 649.5 ± 0.1 | satellite | |
| Co | 12.62 | 775.8 ± 0.4- | Co2p3-1, Co2p3-2, | GL(30) |
| | | 792.5 ± 0.4 | Co2p3 satellite | |
| Zr | 7.04 | 178.0-188.5 | Zr3d3, Zr3d1 | GL(30) |

For Zr and Co peaks, constraints are set for each defined peak according to Table 1b.

TABLE 1b
XPS fitting constraints for peaks fitting.

| | | Fitting range | FWHM | |
|---|---|---|---|---|
| | Defined | constraint | constraint | Area |
| Element | peak | (eV) | (eV) | constraint |
| Zr | Zr3d1 | 184.0-188.5 | Equal to Zr3d3 | 66.7% of Zr3d3 |
| | Zr3d3 | 178.0-184.0 | 0.5-4.0 | No constraint set |
| Co | Co2p3-1 | 776.0-780.9 | 0.5-4.0 | No constraint set |
| | Co2p3-2 | 781.0-785.0 | 0.5-4.0 | No constraint set |
| | Co2p3 | 785.1-792.0 | 0.5-6.0 | No constraint set |
| | satellite | | | |

The Zr surface contents as determined by XPS are expressed as a molar fraction of Zr in the surface layer of the particles divided by the total content of Ni, Mn, Co, and Zr in said surface layer. It is calculated as follows: fraction of

$$Zr = {Zr}_{B} = \frac{Zr ( at \% )}{Ni ( at \% ) + Mn ( at \% ) + Co ( at \% ) + Zr ( at \% )} .$$

### E) Sulfide Solid-State Battery Testing

### E1) Sulfide Solid-State Battery Preparation

### Positive Electrode Preparation:

For the preparation of a positive electrode, a slurry contains positive electrode active material powder, Li—P—S based solid electrolyte, carbon (Super-P, Timcal), and binder (RC-10, Arkema)—with a formulation of 64.0:30.0:3.0:3.0 by weight—in butyl acetate solvent is mixed in Ar-filled glove box. The slurry is casted on one side of an aluminum foil followed by drying the slurry coated foil in a vacuum oven to obtain a positive electrode.

The obtained positive electrode is punched with a diameter of 10 nm wherein the active material loading amount is around 4 mg/cm².

### Negative Electrode Preparation:

For the preparation of negative electrode, Li foil (diameter 3 mm, thickness 100 μm) is placed centered on the top of In foil (diameter 10 nm, thickness 100 μm) and pressed to form Li—In alloy negative electrode.

### Separator

For the preparation of separator which also has a function of the solid electrolyte in a battery, the Li—P—S based solid electrolyte is pelletized with a pressure of 250 MPa to obtain 100 μm pellet thickness.

### Cell Assembly

A sulfide solid-state battery is assembled in an argon-filled glovebox with such order from bottom to top: positive electrode comprising Al current collector with the coated part on the top—separator—negative electrode with Li side on the top—Cu current collector. The stacked components are pressed together with a pressure of 250 MPa and placed in an external cage to prevent air exposure.

### E2) Testing Method

The testing method is a conventional “constant cut-off voltage” test. The conventional cell test in the present invention follows the schedule shown in Table 2. Each cell is cycled at 60° C. using a Toscat-3100 computer-controlled galvanostatic cycling station (from Toyo). The schedule uses a 1 C current definition of 160 mA/g. The initial charge capacity (CQ1) and discharge capacity (DQ1) are measured in constant current mode (CC) at C rate of 0.1 C in below voltage range:
4.3 V to 2.5 V (Li/Li⁺) or 3.7 V to 1.9 V (InLi/Li⁺) for CEX1, EX1, CEX2, and EX2.
4.2 V to 2.5 V (Li/Li⁺) or 3.6 V to 1.9 V (InLi/Li⁺) for CEX3.1 and CEX3.2.

The irreversible capacity IRRQ is expressed in % as follows:

$$IRRQ ( \% ) = \frac{( C Q 1 - D Q 1 )}{C Q 1} \times 100$$

TABLE 2
Cycling schedule for sulfide solid-state battery testing method

| | Charge | | | | Discharge | | | |
|---|---|---|---|---|---|---|---|---|
| | | End | Rest | V/Li metal | | End | Rest | V/Li metal |
| Patent ID | C Rate | current | (min) | (V) | C Rate | current | (min) | (V) |
| CEX1, EX1, | 0.1 | — | 30 | 4.3 | 0.1 | — | 30 | 2.5 |
| CEX2, and EX2 | | | | | | | | |
| CEX3.1 and | 0.1 | — | 30 | 4.2 | 0.1 | — | 30 | 2.5 |
| CEX3.2 | | | | | | | | |

### F) Carbon Analyzer

The content of carbon of the positive electrode active material powder is measured by Horiba Emia-Expert carbon/sulfur analyzer. 1 gram of hNMC powder is placed in a ceramic crucible in a high frequency induction furnace. 1.5 gram of tungsten and 0.3 gram of tin as accelerators are added into the crucible. The powder is heated at a programmable temperature wherein gases produced during the combustion are then analyzed by Infrared detectors. The analysis of CO₂ and CO determines carbon concentration.

The invention is further illustrated by the following (non-limitative) examples:

### Comparative Example 1

CEX1 is obtained through a solid-state reaction between a lithium source and a transition metal-based source running as follows:
1) Co-precipitation: a transition metal-based oxidized hydroxide precursor with metal composition of Ni_{0.83}Mn_{0.12}Co_{0.05} is prepared by a co-precipitation process in a large-scale continuous stirred tank reactor (CSTR) with mixed nickel-manganese-cobalt sulfates, sodium hydroxide, and ammonia.
2) First mixing: the transition metal-based oxidized hydroxide precursor and LiOH as a lithium source are homogenously mix with a lithium to metal M′ (Li/M′) ratio of 0.96 in an industrial blending equipment to obtain a mixture.
3) First heating: the mixture from Step 2) is heated at 765° C. for 10 hours under an oxygen atmosphere. The heated powder is crushed, classified, and sieved so as to obtain an intermediate product.
4) Second mixing: the heated powder from Step 3) and LiOH as a lithium source are homogenously mixed with a lithium to metal M′ (Li/M′) ratio of 1.02 in an industrial blending equipment to obtain a mixture.
5) Second heating: the mixture from Step 4) is heated at 770° C. for 10 hours under an oxygen atmosphere so as to obtain CEX1 having M′ comprising Ni, Mn, and Co in a ratio Ni:Mn:Co of 0.829:0.120:0.050 as obtained by ICP. CEX1 has a D50 of 6 μm.

Optionally, a source of dopant can be added in the co-precipitation process in Step 1) or in the mixing step in the Step 2) or Step 4) together with lithium source. A certain element can be added as a dopant, for instance, to improve the electrochemical properties of the positive electrode active material.

### Example 1

EX1, is obtained through following steps:

1) Wet Mixing: Step 1a) to Step 1c) Below is Applied to Introduce Zr into the Positive Electrode Active Material

Step 1a) Zr solution preparation: 0.5 mol % of Zr from Zr-propoxide (70 wt % Zr-propoxide in n-propanol solution), 1.0 mol % of Li-ethoxide powder, each with respect to the total molar contents of Ni, Mn, and Co in the intermediate product, and ethanol solvent are mixed to form a solution. The amount of ethanol solvent is 55 wt. % of the total weight of the designated CEX1 to mix in the Step 1b).

Step 1b) Mixing: CEX1 is mixed with Zr solution prepared in Step 4a) for 20 minutes in a heatable reactor.

Step 1c) Heating: 70° C. heat is applied to reactor in Step 4b) while at the same time reactor is connected to a vacuum pump to evaporate volatile phases. The product obtained from this step is a dried powder.

5) Heating: the dried powder from Step 1c) is heated at 350° C. for 6 hours under an oxygen atmosphere so as to obtain EX1 having M′ comprising Ni, Mn, Co and Zr in a ratio Ni:Mn:Co:Zr of 0.825:0.120:0.050:0.005 as obtained by ICP. EX1 has a D50 of 6 μm.

### Comparative Example 2

CEX2 is obtained through the same procedure as CEX1, except that the second heating temperature in Step 3) is 730° C.

### Example 2

EX2 is obtained through the same procedure as EX1, except that CEX2 is used instead of CEX1.

### Comparative Example 3

CEX3.1 is obtained through a solid-state reaction between a lithium source and a transition metal-based source running as follows:
1) Co-precipitation: a transition metal-based oxidized hydroxide precursor with metal composition of Ni_{0.64}Mn_{0.17}Co_{0.20} is prepared by a co-precipitation process in a large-scale continuous stirred tank reactor (CSTR) with mixed nickel-manganese-cobalt sulfates, sodium hydroxide, and ammonia.
2) Mixing: the transition metal-based oxidized hydroxide precursor and LiOH as a lithium source are homogenously mix with a lithium to metal M′ (Li/M′) ratio of 1.03 in an industrial blending equipment to obtain a mixture.
3) First heating: the mixture from Step 2) is heated at 860° C. for 10 hours under an oxygen atmosphere. The heated powder is crushed, classified, and sieved so as to obtain an intermediate product.
4) Second heating: the intermediate product from Step 3) is heated at 350° C. for 6 hours under an oxygen atmosphere so as to obtain CEX3.1 having M′ comprising Ni, Mn, and Co in a ratio Ni:Mn:Co of 0.638:0.165:0.197 as obtained by ICP. CEX3.1 has a D50 of 10 μm.

CEX3.2, is obtained through a solid-state reaction between a lithium source and a transition metal-based source running as follows:
1) Co-precipitation: a transition metal-based oxidized hydroxide precursor with metal composition of Ni_{0.64}Mn_{0.17}Co_{0.20} is prepared by a co-precipitation process in a large-scale continuous stirred tank reactor (CSTR) with mixed nickel-manganese-cobalt sulfates, sodium hydroxide, and ammonia.
2) Mixing: the transition metal-based oxidized hydroxide precursor and LiOH as a lithium source are homogenously mix with a lithium to metal M′ (Li/M′) ratio of 1.03 in an industrial blending equipment to obtain a mixture.
3) First heating: the mixture from Step 2) is heated at 860° C. for 10 hours under an oxygen atmosphere. The heated powder is crushed, classified, and sieved so as to obtain an intermediate product.
4) Wet mixing: Step 4a) to Step 4c) below is applied to introduce Zr into the positive electrode active material

Step 4a) Zr solution preparation: 0.6 mol % of Zr from Zr-propoxide (70 wt % Zr-propoxide in n-propanol solution), 1.2 mol % of Li-ethoxide powder, each with respect to the total molar contents of Ni, Mn, and Co in the intermediate product, and ethanol solvent are mixed to form a solution. The amount of ethanol solvent is 55 wt. % of the total weight of the designated intermediate product to mix in the Step 4b).

Step 4b) Mixing: intermediate product obtained from Step 3) is mixed with Zr solution prepared in Step 4a) for 20 minutes in a heatable reactor.

Step 4c) Heating: 70° C. heat is applied to reactor in Step 4b) while at the same time reactor is connected to a vacuum pump to evaporate volatile phases. The product obtained from this step is a dried powder.

5) Second heating: the dried powder from Step 4c) is heated at 350° C. for 6 hours under an oxygen atmosphere so as to obtain CEX3.2 having M′ comprising Ni, Mn, Co and Zr in a ratio Ni:Mn:Co:Zr of 0.632:0.164:0.198:0.006 as obtained by ICP. CEX3.2 has a D50 of 10 μm.

### Example 3

EX3 is obtained through the same procedure as EX1, except that in CEX1 preparation, 2500 ppm Zr is added in Step 2) first mixing, together with Li source, and the second heating temperature in Step 5) is 725° C.

### Example 4

EX4 is obtained through the same procedure as EX1, except that in CEX1 preparation, 2500 ppm Zr is added in Step 2) first mixing, together with Li source, and the second heating temperature in Step 5) is 750° C.

TABLE 3
Summary of the primary particle diameter, composition, and the corresponding
electrochemical properties of example and comparative examples.

| | Average | | | | | | | |
|---|---|---|---|---|---|---|---|---|
| | primary | | | | | | Electrochemical | |
| | particle | | ICP | | | | property | |
| | diameter | Carbon | Ni | | XPS | XPS/ICP | DQ1 | IRRQ |
| ID | (nm) | (ppm) | (mol %) | Zr_{A}* | Zr_{B}* | Zr_{B}/Zr_{A} | (mAh/g) | (mAh/g) |
| CEX1 | 383 | 379 | 82.9 | 0.00 | 0.00 | n/a** | 114.7 | 33.2 |
| EX1 | 383 | 950 | 82.5 | 0.0047 | 0.62 | 132.4 | 173.4 | 18.6 |
| CEX2 | 292 | 358 | 82.9 | 0.00 | 0.00 | n/a** | 119.3 | 30.0 |
| EX2 | 292 | 1497 | 82.6 | 0.0048 | 0.77 | 161.6 | 164.6 | 18.5 |
| CEX3.1 | 371 | 178 | 63.8 | 0.00 | 0.00 | n/a** | 126.1 | 29.5 |
| CEX3.2 | 371 | 549 | 63.2 | 0.0059 | 0.73 | 123.1 | 151.0 | 12.4 |
| EX3 | 297 | 1562 | 82.4 | 0.0074 | 0.65 | 88.8 | 171.5 | 15.8 |
| EX4 | 338 | 1382 | 82.4 | 0.0070 | 0.69 | 99.0 | 180.1 | 14.5 |

*Relative to molar contents of Ni, Mn, Co, and Zr
**Not applicable because Zr_{A} is 0.

Table 3 summarizes the primary particle diameter, composition, and the corresponding electrochemical properties of example and comparative examples. The average primary particle diameter of CEX1 and EX1 are 383 nm, larger than the average primary particle diameters of CEX2 and EX2 which are 292 nm. Likewise, average primary particle diameter of EX4 is larger than EX3, which is linked with the higher heating temperature applied in the Step 5). Positive electrode active material CEX1, EX1, CEX2, EX2, EX3, and EX4 comprise around 83 mol % of Ni. CEX3.1 and CEX3.2 with Ni content around 64 mol % have average primary particle diameter of 371 nm. The primary particle SEM images of EX1, EX2, and CEX3.2 are shown in FIG. 1b, 1c, and 1d, respectively. The images contain drawn lines and number to identify primary particle in order to obtain the average primary particle diameter.

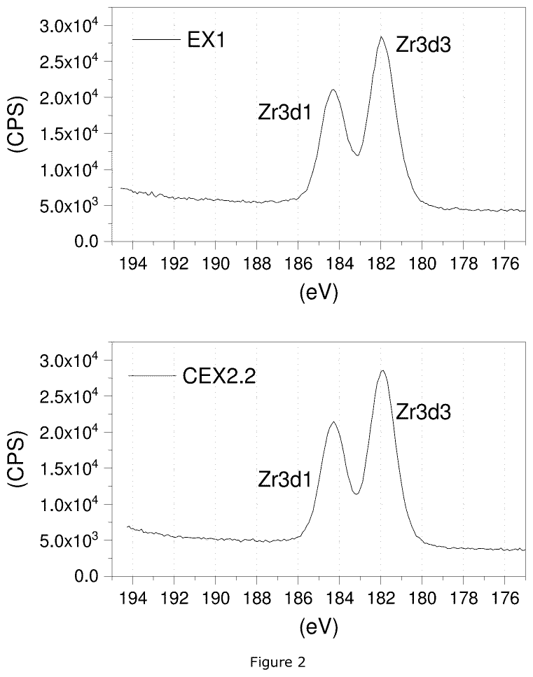

In the Table 3, the XPS analysis result of EX1, EX2, CEX3.2, EX3, and EX4 showing Zr atomic ratio (equivalent with molar ratio) with respect to the total atomic fraction of Ni, Mn, Co, and Zr (Zr_{B}). The table also compares the result with that of ICP. The Zr_{B} higher than 0 indicates said Zr is presence in the surface of the positive electrode active material as associated with the XPS measurement which signal is acquired from the first few nanometers (e.g. 1 nm to 10 nm) of the uppermost part of a sample, i.e. surface layer. On the other hand, Zr atomic ratio obtained from ICP measurement (Zr_{A}) is from the entire particles. Therefore, the ratio of XPS to ICP (Zr_{B}/Zr_{A}) higher than 1 indicates said elements Zr presence mostly on the surface of the positive electrode active material. The higher Zr_{B}/Zr_{A} value corresponds with the more Zr presence in the surface of positive electrode active material. Zr_{B}/Zr_{A} in EX1, EX2, CEX3.2, EX3, and EX4 are all higher than 50, which confirm the effectivity of Zr treatment according to this invention. The representative of XPS spectra showing Zr3d5 and 3d3 peaks of EX1 and EX2 are displayed in FIG. 2.

Carbon content in positive electrode active material after Zr treatment is higher comparing with before treatment which associated with a better electrochemical performance of the active material. Carbon is originated from the Zr alkoxide compound used in the treatment.

For positive electrode active material having Ni content of at least 70 mol %, the combination of primary particle with average diameter of at least 250 nm and Zr_{B}/Zr_{A} higher than 50.0 can achieve the objective of the present invention, which is to provide a positive electrode active material having an improved first charge capacity of at least 160 mAh/g in the solid-state battery.

1-17. (canceled)

18. A positive electrode active material for solid-state batteries, wherein the positive electrode active material comprises Li, M′, and oxygen, wherein M′ comprises:
Ni in a content x between 70.0 mol % and 95.0 mol %, relative to M′;
Co in a content y between 0.0 mol % and 40.0 mol %, relative to M′;
Mn in a content z between 0.0 mol % and 40.0 mol %, relative to M′,
D in a content a between 0.0 mol % and 2.0 mol %, relative to M′, wherein D comprises at least one element of the group consisting of: Al, B, Ba, Ca, Cr, Fe, Mg, Mo, Nb, S, Si, Sr, Ti, Y, V, W, and Zn, and,
Zr in a content b between 0.1 mol % and 5.0 mol %, relative to M′,
wherein x, y, z, a, and b are measured by ICP,
wherein x+y+z+a+b is 100.0 mol %,
wherein the positive electrode active material has a Zr content Zr_{A} defined as
$$\frac{b}{( x + y + z + b )} ,$$
wherein the positive electrode active material has a Zr content Zr_{B}, wherein Zr_{B} is determined by XPS analysis, wherein Zr_{B} is expressed as molar fraction compared to the sum of molar fractions of Co, Mn, Ni, and Zr as measured by XPS analysis,
wherein the ratio Zr_{B}/Zr_{A}>50.0,
wherein the positive electrode active material comprises secondary particles having a plurality of primary particles,
wherein said primary particles have an average diameter of at least 250 nm as determined by measuring primary particle size in an image taken by SEM.

19. Positive electrode active material according to claim 18, wherein the primary particles have an average diameter of at least 280 nm.

20. A positive electrode active material according to claim 18, wherein the ratio Zr_{B}/Zr_{A} is at least 80.

21. A positive electrode active material according to claim 18, wherein the ratio Zr_{B}/Zr_{A} is at most 500.

22. Positive electrode active material according to claim 18, wherein x≥77.0 mol %.

23. Positive electrode active material according to claim 18, wherein x≤91.0 mol %.

24. Positive electrode active material according to claim 18, wherein 0 mol %≤y≤20 mol %.

25. Positive electrode active material according to claim 18, wherein b/(a+x+y+z) is at least 0.10 mol % and at most 1.00 mol %.

26. Positive electrode active material according to claim 18, wherein the secondary particle median size D50 is at least 2.0 μm and at most 15.0 μm, as determined by laser diffraction particle size analysis.

27. Positive electrode active material according to claim 18, wherein the carbon content is at least 600 ppm and at most 8000 ppm, as determined by carbon analyzer.

28. A method for the manufacturing of a positive electrode active material for solid-state batteries, comprising the consecutive steps of
preparing a lithium transition metal-based oxide compound,
mixing said lithium transition metal-based oxide compound with a source of Zr, preferably Zr alkoxide in lithium alkoxide containing alcohol solvent, thereby obtaining a mixture, and
heating the mixture in an oxidizing atmosphere in a furnace at a temperature between 350° C. and less than 500° C., for a time between 1 hour and 20 hours so as to obtain the positive electrode active material.

29. The method according to claim 28, wherein the method comprises a further step, before heating said mixture, of drying said mixture.

30. The method according to claim 28, wherein the method comprises a further step, before heating said mixture, of drying said mixture by means of vacuum heating.

31. The method according to claim 28, wherein the positive electrode active material is a positive electrode active material comprising Li, M′, and oxygen, wherein M′ comprises:
Ni in a content x between 70.0 mol % and 95.0 mol %, relative to M′;
Co in a content y between 0.0 mol % and 40.0 mol %, relative to M′;
Mn in a content z between 0.0 mol % and 40.0 mol %, relative to M′,
D in a content a between 0.0 mol % and 2.0 mol %, relative to M′, wherein D comprises at least one element of the group consisting of: Al, B, Ba, Ca, Cr, Fe, Mg, Mo, Nb, S, Si, Sr, Ti, Y, V, W, and Zn, and,
Zr in a content b between 0.1 mol % and 5.0 mol %, relative to M′,
wherein x, y, z, a, and b are measured by ICP,
wherein x+y+z+a+b is 100.0 mol %,
wherein the positive electrode active material has a Zr content Zr_{A} defined
$$\frac{b}{( x + y + z + b )} ,$$
wherein the positive electrode active material has a Zr content Zr_{B}, wherein Zr_{B} is determined by XPS analysis, wherein Zr_{B} is expressed as molar fraction compared to the sum of molar fractions of Co, Mn, Ni, and Zr as measured by XPS analysis,
wherein the ratio Zr_{B}/Zr_{A}>50.0,
wherein the positive electrode active material comprises secondary particles having a plurality of primary particles,
wherein said primary particles have an average diameter of at least 250 nm as determined by measuring primary particle size in an image taken by SEM.

32. A solid-state battery comprising the positive electrode active material according to claim 18.

33. Solid-state battery according to claim 32, wherein said solid-state battery comprises a sulfide based solid electrolyte comprising Li, P, and S.

34. An electric vehicle or a hybrid electric vehicle comprising the battery according to claim 32.
